(19) United States
(12) Patent Application Publication
(10) Pub. No.: US 2004/0078305 A1
(43) Pub. Date: Apr. 22, 2004

(54) Internet sales tracking system for reimbursing display store costs

(76) Inventor: Scott Weller, Marshall, MI (US)

Correspondence Address: MICHAEL TAVELLA, 2051 BRIGADIER DRIVE, ANCHORAGE, AK, 99507, US

(21) Appl. No.: 10/726,928

(22) Filed: Dec. 3, 2003

Related U.S. Application Data
(63) Continuation of application No. 09/553,491, filed on Apr. 20, 2000.

(51) Int. Cl. G06F 17/60

(52) U.S. Cl. 705/27

(57) ABSTRACT

A product tracking and income distribution method that determines, via a code, which store and or sales representative assisted with a product sale that a consumer purchased over the Internet. The apparatus uses an Internet site with a database for storing codes that retrieves and holds detailed product information, retailer profiles, and potential representative's identities. When a consumer views a product within a traditional retail store and is interested in buying the product, a master code is generated by the store that details the store profile, product details, and sales representative (if applicable) involved with the product viewing. The consumer uses the code and places an order online. The code utilized by the consumer ensures the store earns a preprogrammed viewing fee and the sales representative earns his/her commissions from the predetermined commission of the product code purchase. This code can also determine other important purchasing information such as taxes due, product terms, product price, and shipping costs.

### CROSS REFERENCE TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

1. Field of the Invention

This invention relates to Internet sales systems and particularly Internet sales system that provide reimbursement to established retail locations for demonstrating products.

2. Description of Related Art

For many years, products have been sold to consumers using a network of distributors and retailers. Manufactures sell large volumes of product to the distributors who then resell that product to retail outlets, who in turn sell the products to end consumers. This chain can be broken by manufactures selling directly to consumers, or by distributors bypassing retail stores. The problem with this is that it tends to undermine the strength of the retail store. Customers begin to use the retail store as a showroom. They inspect the goods, test the equipment, evaluate alternatives, and then buy from the direct source; the direct source usually having a much lower price than the retail store.

The advent of the Internet has exacerbated this problem by creating an efficient business model that allows consumers to purchase directly from the manufacturer or other retailers online. Less handling and wholesaler mark-up, provide efficient price purchasing opportunities. Because of this, many retail businesses are missing sales to direct online purchases.

Another variation of this problem is the example of higher volume retailers that steal sales from other franchisees within the same company. For example, Ford motor company (Ford) has many franchises that are have better pricing than other Ford franchises because of the volume pricing. Currently, a well-informed consumer could go to the local dealership and test drive vehicles to learn the model of choice. Knowing the dealership is a small volume dealer; the consumer enters the Ford Internet site and bids the model of choice at 15 dealerships. The high volume dealerships within larger cities are substantially lower in price than the dealership that the consumer test-drove the vehicle. The consumer than buys the vehicle from the lowest price dealer. Consequently, not only does the smaller dealer lose the sale because of access to the Internet; the viewing dealership also spends resources in showing the product. The future of the smaller franchise dealerships is in jeopardy once the consumer realizes the power of the Internet bidding process.

Another example of the Internet disrupting the “brick and mortar” retailers is the clothing industry. For example, consumers shop for wedding dresses at typical retail outlets. Once the dress of choice is discovered, the consumer copies the tag information. The consumer then shops online for the same dress which they find at a reduced price, since the online retailer does not have the same overhead and cost of goods burden. To combat this practice, traditional brick and mortar stores now are tearing off the wedding dress labels in hopes to dissuade the consumer from this practice.

Because of this growing trend, brick and mortar companies are rushing to build online alliances and direct selling methods. Their current business models may not offer the best pricing on certain materials. These stores seek to ship products directly to the consumer from the retailers' distribution centers. An example of this is Office Max, where a consumer can either buy the product at the their stores or on the Office Max web site. This business model still carries major inventory at the traditional stores and distribution centers to cater to the consumer demand.

Another example of a new service is one provided by Gateway Computers. Gateway has viewing stores for their own computer systems. The company owns the stores. Store sales are not important. The codes they use for their products are based on national product codes. A consumer can walk into their store, review a product, and place an order over the Internet. However, the store sales are not tracked and the sales representatives have no means to be compensated on commissions. The Gateway selling solution does not call for the transfer of money back to the original stores or sales representatives. All of their stores are corporately owned so franchisee profitability is not an issue.

### BRIEF SUMMARY OF THE INVENTION

This invention is a system that creates viewing stores that allow a consumer to view items and then purchase the product online at one price plus delivery. The brick and mortar stores can sell staples for immediate consumption and provide samples of other higher price items for consumer viewing. This system eliminates large inventories in the stores that hurt cash flow and profitability. Distribution costs to the stores are eliminated. Manufacturers provide free samples of there products to be viewed. The consumer benefits from a bigger viewing section because the store merchandising space can be reduced only to view products. Retailers may also request consumer viewing space be rented from the manufacturer. Manufacturers ship product directly to the consumers. Consumers are able to purchase the product online for one price including taxes and delivery. Consumer dollars are distributed through the Internet systems instead of the store. The cash then routes back to the to the parties that assisted with the sale.

The manufacture tracking system comprises a software based system accessed over the internet that makes use of consumer direct ordering capabilities, and a code generations ability that tracks the product, the store and the representative that assisted with the consumer's online purchase.

The new proposed business model allows the manufacturer or online retail operation the ability to control consumer purchasing information while providing tracking and dollar distributions to the proper store and representative involved with consumer online product purchase.

For example, in order for the Ford Motor Company to prevent consumers from viewing cars at smaller dealerships and purchasing the same car from high volume dealerships, Ford implements the system as follows: each dealership receives a code that determines the store location and each representative receives a code that identifies their work performance. All cars with each option combination are assigned a code that can be identified by the main database in which the consumer places the automobile order. All cars under this system are placed under one price plus delivery, options, and tax. After a consumer views a car at a dealership, the consumer is provided by the Ford Dealership with a code that identifies the dealership, car and the representative (if necessary) that influenced the sale. When the consumer places an order on the Ford internet site, the code is programmed to fulfill the consumer order, while transferring predetermined payment dollars to the dealership as a viewing fee, transferring the predetermined commissions to the sales representative, and transferring the predetermined dollars to the manufacturer.

Another embodiment this invention is a system that can be used with other retailers that are not affiliated with the manufacturer. In this embodiment, each retailer is given a store code, and representative codes for their sales force that are programmed for different earning potential for each product code that is attached. The consumer samples the product and decides to purchase. The consumer is directed to an ordering web site and given a product code with an attached store/representative code to signify the store and the sales representative that assisted with the sale. After the consumer purchases the product with the code he/she received, the consumer secured payment is distributed to in the amount of the product viewing fee for the identified store, the preprogrammed commissions for the identified representative, the Internet retailer commissions, the shipping company and the manufacturer. In this way, the present invention provides a method for tracking and distributing information/payments from a consumers purchase over the internet of the product purchased, to the store where the product was viewed, and to a sales representative that may have assisted with the sales.

In another embodiment, the payment can also be transferred and split to the online retailer, manufacturer, and other parties. After the consumer visits a store, a code is generated or provided. The code details are stored within the Internet site database from which the consumer purchases the viewed product. The code can include the particular store profile, the product details and, if necessary, the sales representative information. This code is stored on the Internet site within a database. When the consumer purchases a product, the code, under the specific terms and conditions, determines the product price for the consumer. The terms of sale can be edited for the different retailers and sales representatives identified within the product code. For example, a high volume retail outlet may have a less expensive quoted consumer price. After the consumer entered the code on the internet site and purchased the product, the present invention collects money from consumer and distributes it to the online store, the viewing store (if necessary), the manufacturer, and the representative (if necessary), and other defined business revenue payment structures. Consumers can also provide financial institution information to provide payment to the sale parties.

Another embodiment of the present invention allows an online store to capture and take advantage of the tracking process. An Internet retailer has viewing stores to show items like clothes that are otherwise difficult to sell online. After the consumer views the product, a code is generated for the consumer to use when purchasing a product online. While in the store, a code is generated by the sales representative that identifies him/her and the store. After the consumer pays the Internet retailer with the code, the Internet retailer could send the viewing fee directly to the appropriate store and sales representative.

### BRIEF DESCRIPTION OF THE DRAWINGS

FIG. 1 is a schematic diagram of the information flow of the product-store representative-consumer tracking and consumer transfer of payments made in the preferred embodiment of the invention.

FIG. 2 is a schematic view of the components of the master code FIG. 3 is a schematic view of the configuration of the core handler.

FIG. 4 is a flowchart of the consumer's quoted product price module.

FIG. 5 is a flowchart of the product fulfillment module.

FIG. 5b depicts the allocation of dollars to the respected parties FIG. 6 is a schematic of a user reviewing an account status.

FIG. 7a is the first part of a flowchart showing the payment distribution process.

FIG. 7b is the second part of a flowchart showing the payment distribution process.

FIG. 8 is a schematic showing the payment alterations module.

FIG. 9 is a schematic of the consumer payment process.

FIG. 10 is a detail view of the consumer interface module.

### DETAILED DESCRIPTION OF THE INVENTION

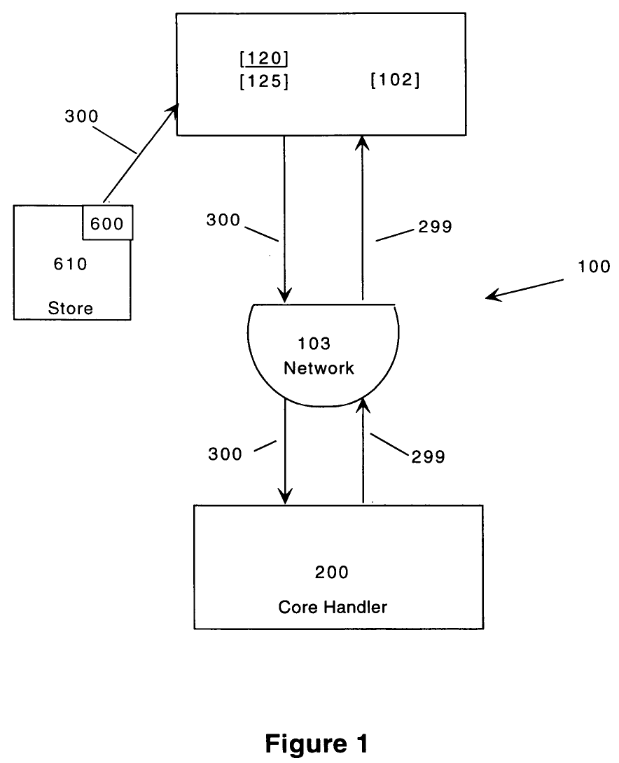

The system uses standard components such as conventional computers, telecommunications services, and output/input devises like computer terminals, printers, and facsimile machines. FIG. 1 is a block diagram of the product tracking and payment distribution system 100. The current system 100 includes a consumer location 102, telephone switch connection network, like MCI or ATT, 103, and a core handler 200. The core handler 200 is a modern server computer system that is active for database response. The core handler's function is to execute software, to store and manage information, and to handle transaction and consumer requests. The consumer location 102 includes a user-input device 120, which in the preferred embodiment is a computer with a modem. Consumer 102 also includes an output device 125 that can be a typical printer or terminal screen. There are many possible input and output devises that can be used. These include items such as a telephone, a personal data assistant, a web site and e-mail. The consumer location visits store 610 and retrieves the master code 300. The consumer location 102 places product order through the network 103 using the core handler 200. Confirmation and shipping details 299 are communicated back to consumer 102.

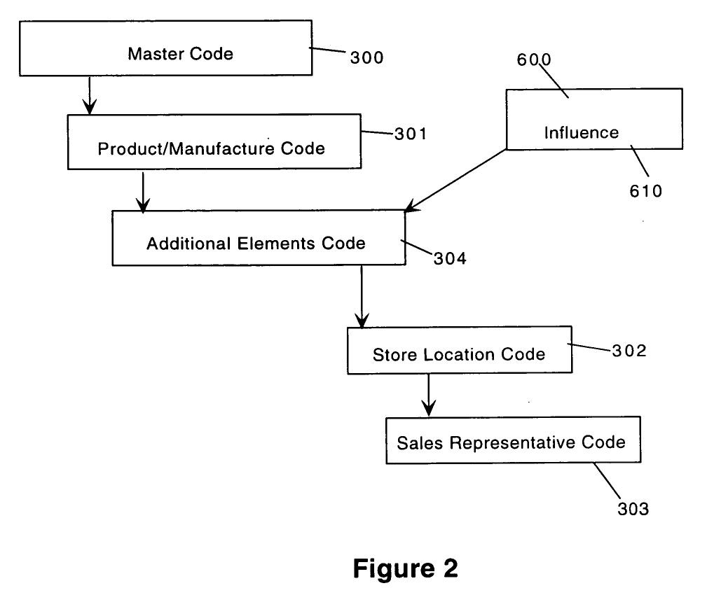

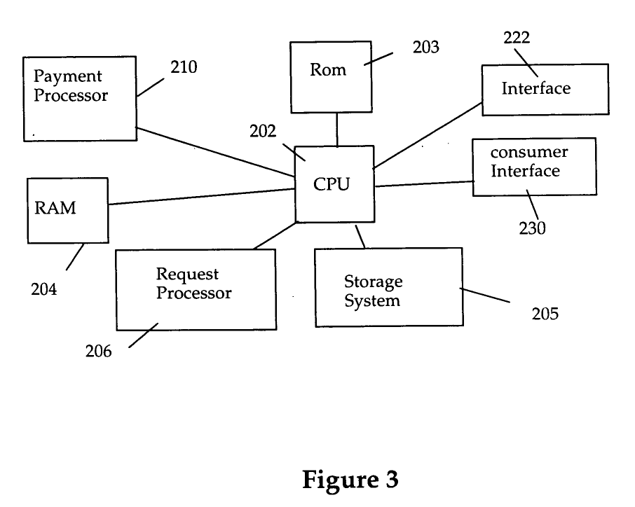

FIG. 2 represents the product tracking and payment distribution business model master code 300 fields. This code includes the specific product or manufacturer code 301. An additional elements code 304 of the master code includes the store location code 302, and a sales representative code 303 for a given online purchase. The additional elements of the master code can be generated by the stores 610 internal computer systems or generated by the manufactures or online retailer's headquarters and presented to the consumer in paper form. In either case, the additional elements code 304 is generated. Thus, the code 304 must have representation within the core handler's databases 200. For example, a representative 600 can give or add the representative code 303 to the master code 300 to ensure the information of his/her efforts is included within the consumer's 102 online purchase.

FIG. 3 is a block diagram of the elements of the core handler 200, which is connected to a conventional network interface device 222 for access to the public telephone network 103. The core handler 200 has a CPU 202, RAM 203, ROM 204, a payment processor 210, a clock 211, and a storage device 205. These components are all common to the art. The storage device 205 must have a request processor 206 and multiple databases 220, 225, 230, 240, 250, 260. The request processor 206 is a software program that requests the consumer's 102 master code 300 information. The rapid response storage device 205 contains the master code databases 220, the pricing database 225, the consumer database 230, the store database 240, the sales database 250, and the manufacturer database 260.

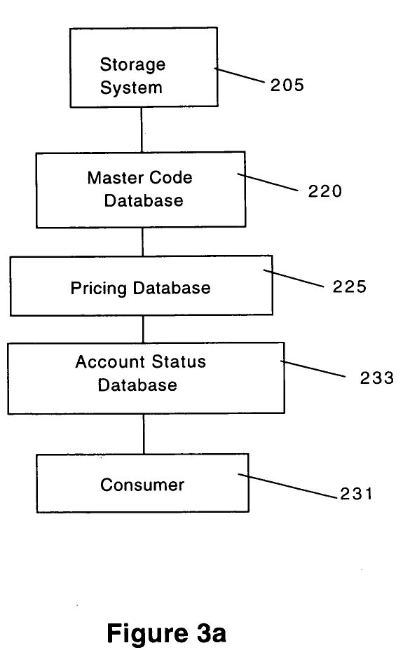

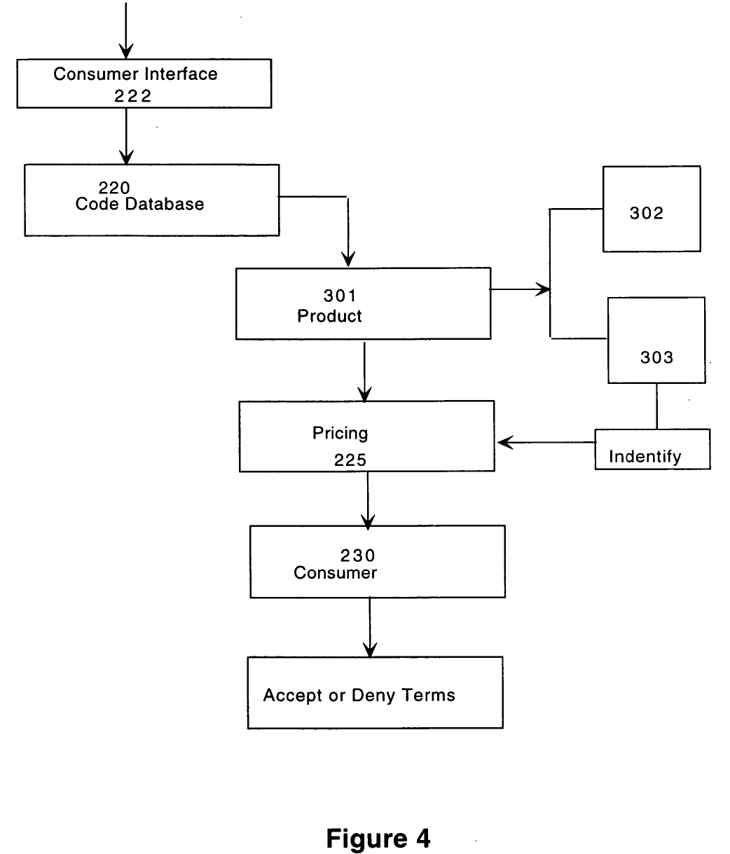

In FIG. 4, the consumer enters the system through the consumer interface 222 at step 701. A consumer 102 then transmits a product order using input 120 and the master code 300, step 702. The code inquiry then initiates a process to determine the product code 301, which displays the product information 309 at step 706 and identifies the additional elements codes, store code 302, and sales representative code 303 at step 704. The pricing database 225 determines the shipping cost and tax fees 707. One embodiment of the invention allows the store code to increase the price quoted to the consumer at step 705 if the store code 302 is embedded within the master code 300. The sales code 302 can also affect the consumer quoted price.

Once the order has been entered, the product cost and product terms are communicated to the consumer 102 at step 708. The consumer can then accept or deny the terms of the product at step 709. The master code 300 can contain preprogrammed product information, sales representative commissions and other information, and the store fees information. However, the code must contain the product or manufacturer code 301 information.

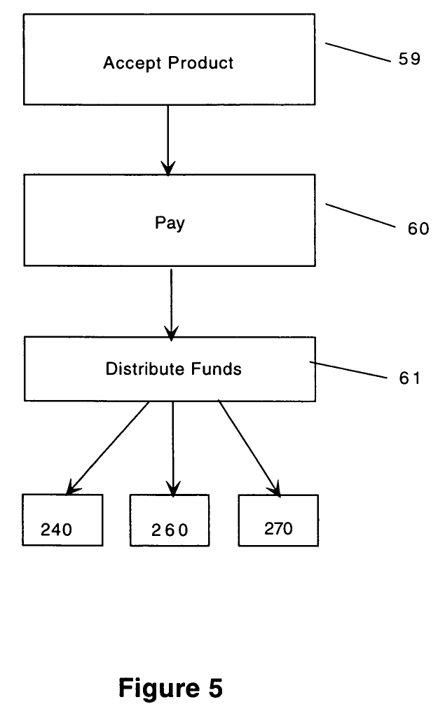

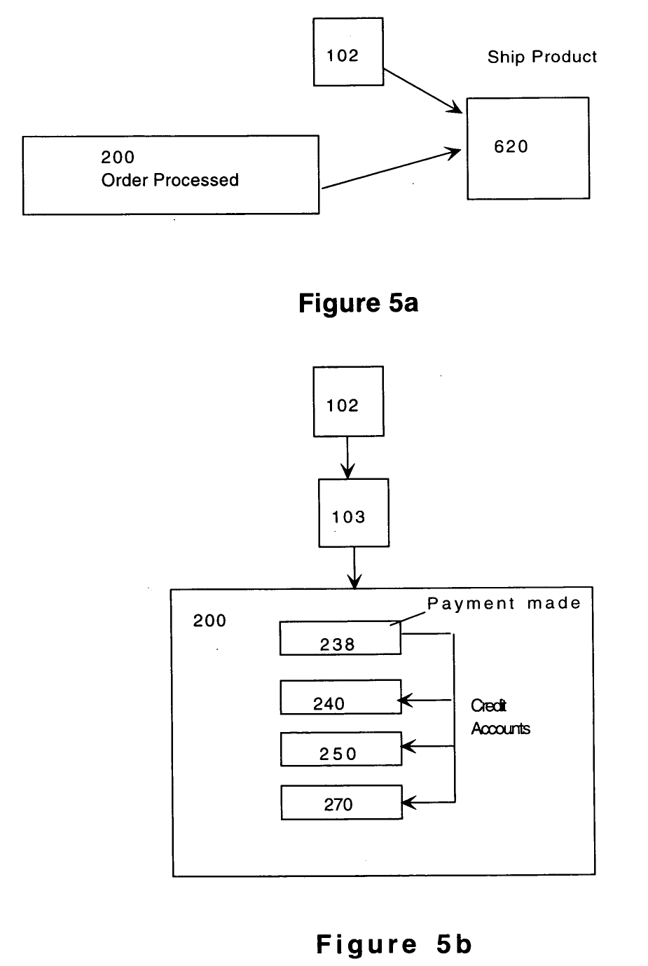

Next, as shown in FIG. 5, the core handler 200 receives the consumers purchase request (over the switched telephone network 103, for example). The core handler 200 takes the purchase request 59 and determines through the database the appropriate product, consumer payment 60, commissions 61 to the sales representatives 610, and store-viewing fees owed. FIG. 5a shows how the core handler 200 sends the consumer's 102 order to a fulfillment location or manufacturer 620 via an output device. The manufacturer or fulfillment location 620 sends the product to the consumer 102 by standard shipping means. FIG. 5b shows the transfer of money to the parties that are identified within the master code. In this case, the master code reveals all parties to be paid within the Account status database 233, which includes, the store database 240, the sales representative database 250, the manufacturer database 270. Other parties are paid from their respected negotiated earnings for the particular product that was ordered. The information and dollars distributed can be either outputted to the participants bank accounts with identity authorization or transferred within the respected Account status databases 233. The account status database 233 provides the respected parties with proper identifications, a secure account status, billing and payment authorization. The account status database 233 is accessed by a specific participant using proper identification.

FIG. 6 has following fields for the Account Status databases 233 that includes 250, 240, 270, 231: a) master code purchased; b) product details (timing)(commissions); c) payment distribution; d) account reviews; and miscellaneous information.

Each respected database can be customized for information to be viewed. The mentioned fields are just a representation of the information captured within the account status databases. Other field structures can be used. For example, the databases can include a competitive information source 267 that consolidates all purchases within a category. Using this source, manufacturers can review their market share information verses their competition's.

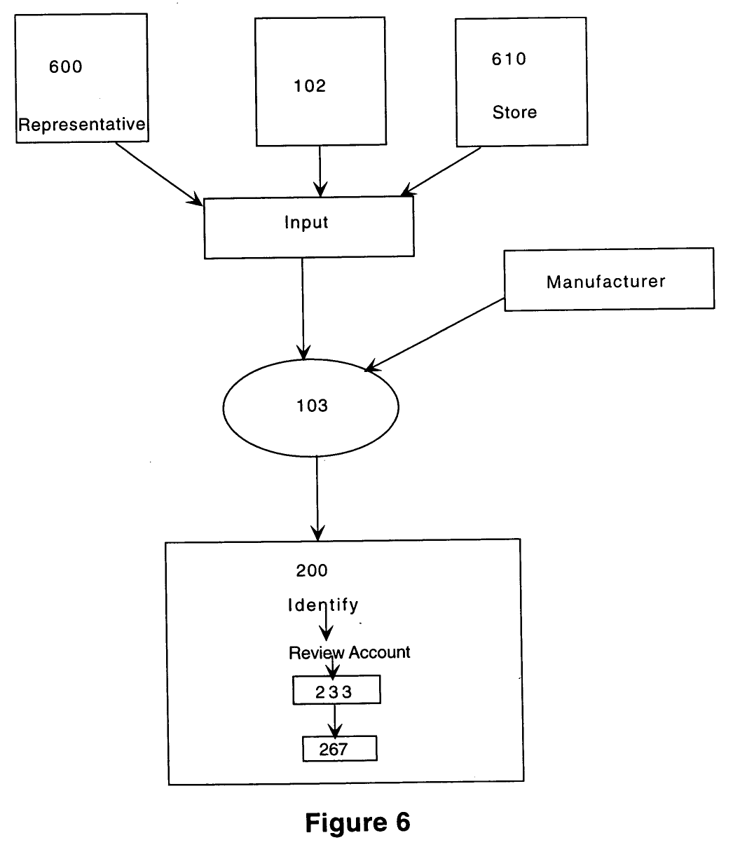

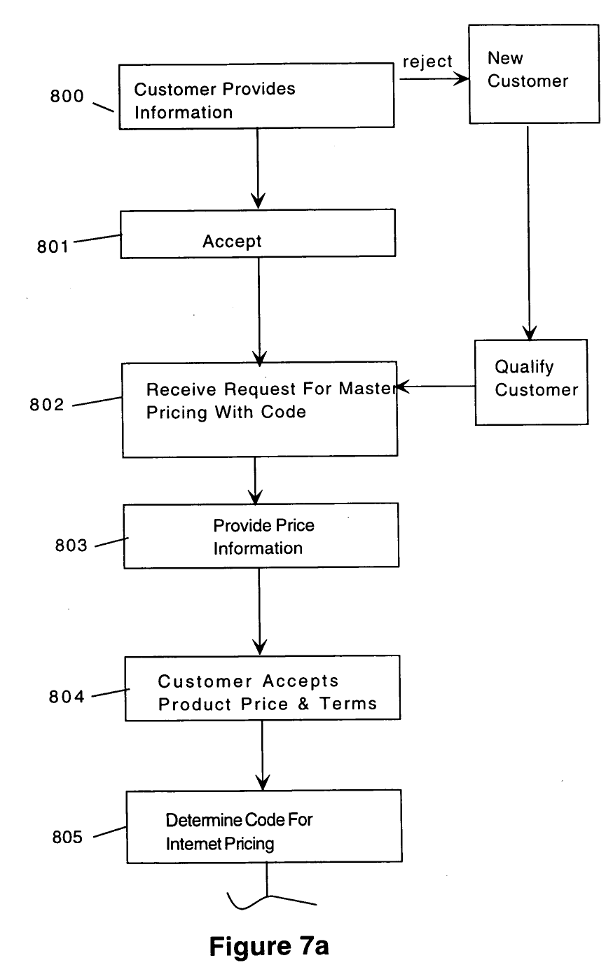

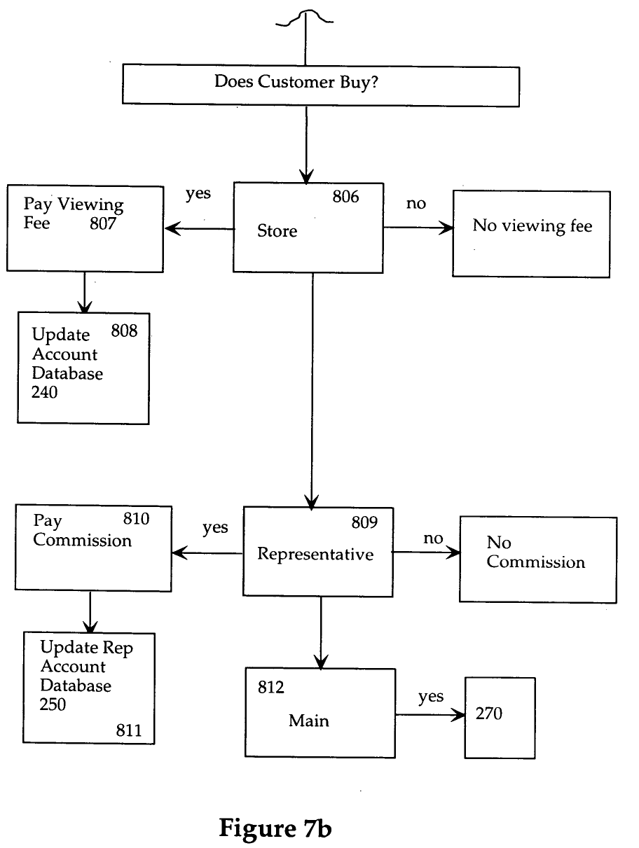

FIGS. 7a and 7b are flow charts of the procedure used by the core handler 200 in executing the software of the request processor 206 to process and identify a consumer by the master code 300 and then accepting a product order and payment. The consumer enters the core handler 200 and must provide proper identification 800. If the consumer is a new customer, the system transfers the new customer to step 801 to qualify the customer. If the consumer 102 is not new and has given the proper identification number, the consumer enters the master code 300 within the database at step 802. The details of the product are provided to the consumer at step 803. The consumer then makes the purchase at step 804. The consumer profile provides all variables required to determine the pricing information from the pricing database. The core handler 200 then takes the master code embedded and determines the other parties involvement within the consumer purchase (if any). The master code along with the additional element codes 304 determines the appropriate store and representative if applicable at step 805. Step 806 is used when a store's information is embedded within the master code 300. If the store is included with the consumer purchase, the store earns the preprogrammed viewing fee at step 807. The payment is updated within the store account status database 240 at step 808. If the master code contains a sales representative code 303, the commissions information is determined at step 810 and updated within 250 at step 811. Because the manufacturer is identified in the master code, the payment information can be transferred to the account 270 at step 812.

The code database 220 contains the product details that correspond to each product or manufacture code. The additional elements code 304, store code 302 and representative code 303, are also included within this database. These databases are accessed by password by the authorized respected parties to program product details, store commissions, and representative fees.

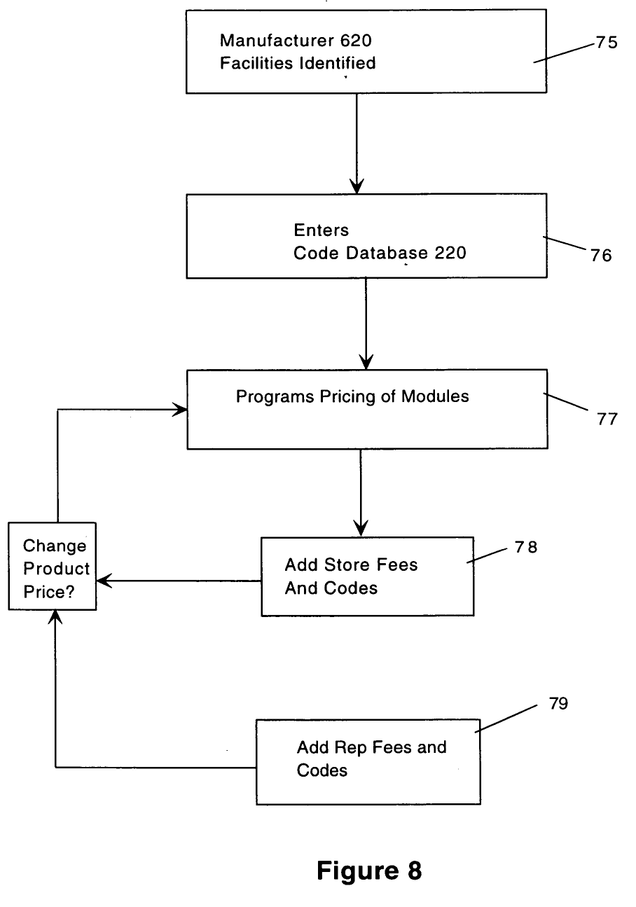

The core handler 200 also has the ability to program the master code terms. FIG. 8 details the programming of each product code. Step 75 shows the manufacturer gives the proper identification to enter the product code database 220. Step 76 verifies that proper entry is made. Once accepted within the database, the manufacture can preprogram the price associated with each product in terms of location, taxes, and other variables at step 77. The manufacture can also determine via the store code 302, product pricing and store viewing fees in step 78 that are linked to that code. The manufacturer can also adjust product pricing via the sales code 303 and set selling commissions in step 79.

The manufacturer database 270 contains the fulfillment requirements of the fulfillment manufacturer or selling agent. The fields required within this database are: a) the product code 301; b) shipping location requirements inserted by the consumer; c) consumer information; d) the store fee; e) the representatives commissions; f) the competitive setting 267; g) the product distribution history; and h) accounts receivable. Other captured information can be programmed within this database to capture sales information if desired.

Finally, the consumer information database 231 includes: a) the customer identification number 10; b) the customer name; c) customer address, telephone number and facsimile number; d) the customer's credit card number; e) the preferred delivery method and time; f) financing terms; and g) the account balance. Each purchase is recorded within a specific customer's account status database. The consumer identifier number 10 is a unique identifier to ensure ability to securely purchase a product on the proposed invention.

The Core handler 200 must ensure the product purchased by the consumer is fulfilled and shipped, and the respected parties receive their payments. The core handler first receives input from the consumer 102 with the master code 300 information. The code's source generates the pricing parameter database to provide exact details to the consumer 102. The consumer places the order and the billing process occurs within database. After payment is made, the code database 220 identifies the code for potential tracking and consumer influence with these parties. The code prompts input from programmed formulas, the store viewing fee, and sales representative commission, from the code that was placed by the consumer 102. The payments are distributed according to the preprogrammed payment product parameters to the shareholders within the account status databases 233. The dollar transfers can be automatically distributed to the respected parties' accounts. The product and consumer details are sent to the fulfillment database 270, or directly to the manufacturer.

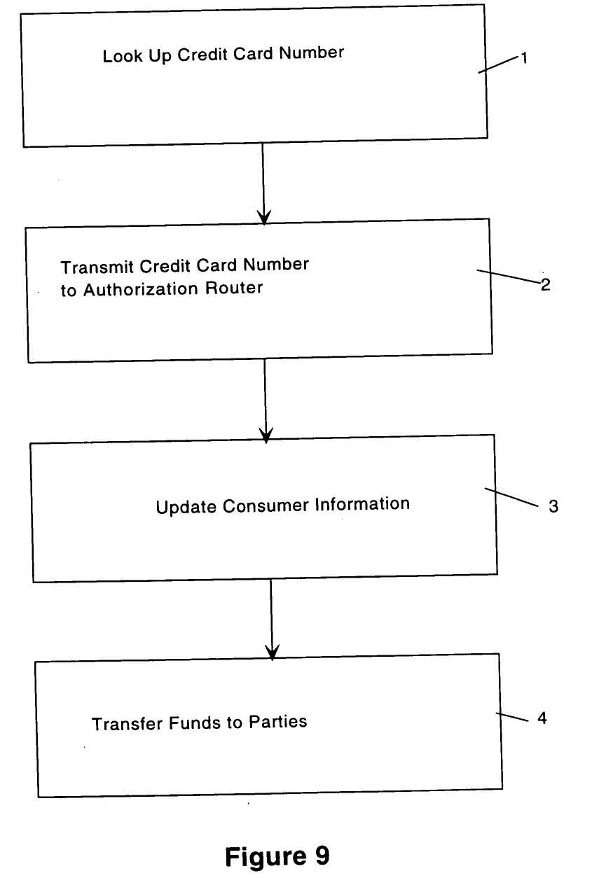

FIG. 9 show a conventional way to process a credit card payment using the system. Using the identification number, the core handler 200 checks the credit in the consumer database in step 1. The core handler 200 then outputs the credit card number to the appropriate credit card processing center in step 2. The consumer database account is updated in step 3. When authorization is received, the appropriate parties involved in the sale are compensated in step 4. Other billing methods may be used as well, without hampering the scope of the present invention.

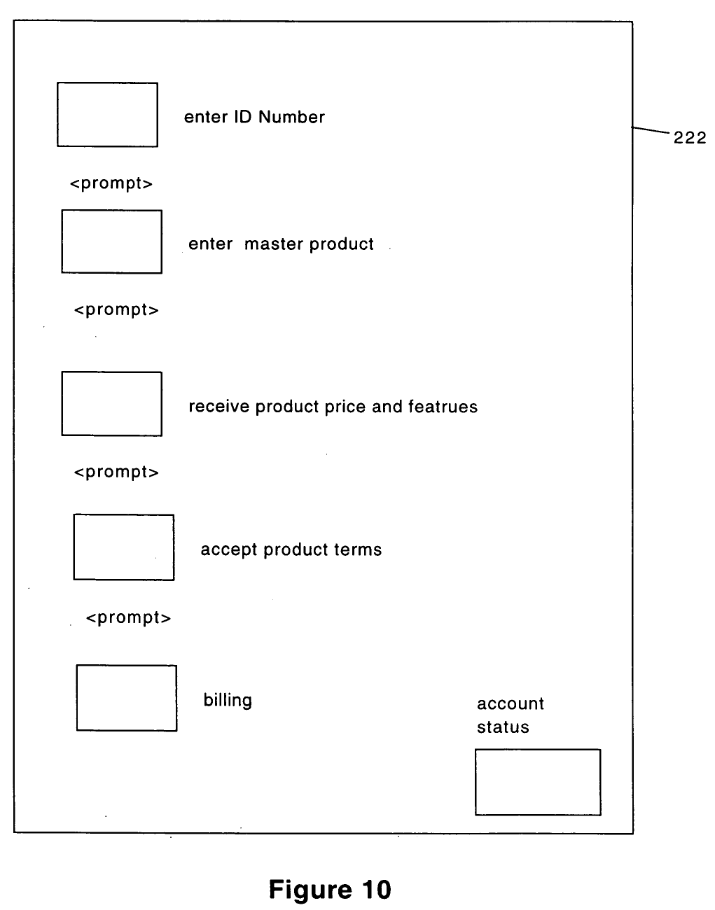

FIG. 10 shows details of the typical consumer interface 222. The consumer must enter an identification code to be prompted to enter the master product code 300. After the consumer enters the code, the consumer is quoted the price. At this point, the consumer has the ability to place the order. Billing is automatic. The interface also allows consumers to access their account.

The present invention allows manufactures the ability to track their sales directly to the consumer. Dollars are not exchanged until the consumer purchases a product. A code is provided to the consumer that determines the product purchased, the store that the consumer viewed the product and the respected sales representative involved with the sale. Once the consumer accepts the price and purchases the product, dollars are exchanged from the consumer to the online retailer, viewing store, sales representative, and the fulfilling manufacturer. Every party involved has the ability to track past sales and review their account status.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof. claims

I claim:

1. An Internet sales tracking system for reimbursing display store costs comprising:
a) a base terminal for use by a consumer;
b) a core handler computer system having capability for database response;
c) a means for accessing said core handler computer system from said base terminal;
d) a master code, generated at a retail location; said master code identifying at least said retail location;
e) a means for accepting said master code from said base terminal, said means for accepting being installed within said core handler computer system; and
f) a means for distributing a payment to said retail location when said consumer orders a product from an internet website that collects said master code from said consumer and transmits said master code to said core handler computer system.

2. The internet sales tracking system for reimbursing display store costs of claim 1 wherein said master code further comprises a retail salesperson identifying code.

3. The Internet sales tracking system for reimbursing display store costs of claim 1 wherein said master code further includes a product code.

4. The Internet sales tracking system for reimbursing display store costs of claim 3 wherein said product code includes a pricing code.

5. The internet sales tracking system for reimbursing display store costs of claim 1 wherein said master code further includes a pre-determined fee distribution system for allocating funds collected from a consumer to participants involved in a transaction.

6. The internet sales tracking system for reimbursing display store costs of claim 1 wherein the base terminal for use by a consumer is located in a consumer's home.

7. The internet sales tracking system for reimbursing display store costs of claim 5 wherein said pre-determined fee distribution system is not activated until a consumer purchases an item using said master code.

8. A method of internet sales tracking for reimbursing display store costs, from a system having a base terminal is for use by a consumer, a core handler computer system having capability for database response, a means for accessing said core handler computer system from said base terminal, a master code, generated at a retail location, said master code identifying at least said retail location, a means for accepting said master code from said base terminal, said means for accepting being installed within said core handler computer system, and
a means for distributing a payment to said retail location when said consumer orders a product from an internet website that collects said master code from said consumer and transmits said master code to said core handler computer system comprising the steps of:
a) visiting a retail location;
b) identifying a desired product;
c) obtaining a master code from said retail location;
d) accessing an internet website that offers said desired product for sale;
e) purchasing said product from said internet website;
f) entering said master code during said purchase;
g) generating a payment to said retail location from a company controlling said website, whereby said payment to said retail location is remuneration for providing viewing services to a consumer, and further wherein said payment is predicated on information contained in said master code.

9. The method of claim 8 wherein the step of accessing an internet website is performed at a consumer's home.

10. The method of claim 8 wherein the step of generating a payment to said retail location is not completed until after a consumer's purchase transaction has been completed and the consumer has caused funds to be transferred for the consumer's purchase transaction.

11. The method of claim 8 wherein the master code contains a product identification code, and a store identification code.

12. The method of claim 11 wherein said master code further includes a sales representative code.
